(19) United States
(12) Patent Application Publication
(10) Pub. No.: US 2024/0098597 A1
(43) Pub. Date: Mar. 21, 2024

(54) HANDOVER BETWEEN TERRESTRIAL NETWORK AND NON-TERRESTRIAL NETWORK

(71) Applicant: SAMSUNG ELECTRONICS CO., LTD., Suwon-si (KR)

(72) Inventor: Seunghyun LEE, Suwon-si (KR)

(73) Assignee: SAMSUNG ELECTRONICS CO., LTD., Suwon-si (KR)

(21) Appl. No.: 18/370,242

(22) Filed: Sep. 19, 2023

(30) Foreign Application Priority Data
Sep. 19, 2022 (KR) 10-2022-0118157

(51) Int. Cl. H04W 36/14; H04B 17/318; H04W 36/30

(52) U.S. Cl. CPC H04W 36/14; H04B 17/328; H04W 36/30

(57) ABSTRACT

A method of a user equipment in a wireless communication system, includes: receiving, from a base station, configuration information including at least one of a pre-condition, a trigger condition, and a cancel condition for a handover from the base station to a satellite; receiving a first reference signal from the base station and a second reference signal from the satellite, respectively; measuring Reference Signal Received Power (RSRP) of each of the first reference signal and the second reference signal; and transmitting a first measurement report to the base station, based on a determination that the trigger condition related to the first reference signal and the pre-condition related to the second reference signal are satisfied.

### CROSS-REFERENCE TO RELATED APPLICATION

This application is based on and claims priority under 35 U.S.C. § 119 to Korean Patent Application No. 10-2022-0118157, filed on Sep. 19, 2022, in the Korean Intellectual Property Office, the disclosure of which is incorporated by reference herein in its entirety.

### BACKGROUND

### 1. Field

The disclosure relates to a method and apparatus for handover between a terrestrial network and a non-terrestrial network.

### 2. Description of Related Art

In 3rd Generation Partnership Project (3GPP) release 18, discussions on the development direction of 5^{th} generation (5G) advanced are underway, and discussions on 6^{th} generation (6G) are also starting. In addition, as a demand for aerial communication using drones, airplanes, or the like increases, discussions on non-terrestrial networks using satellites as base stations are also underway. Accordingly, there is a need for a method for a seamless handover between a terrestrial network and a non-terrestrial network.

### SUMMARY

The disclosure provides a method for a seamless handover between a terrestrial network and a non-terrestrial network.

According to an aspect of the disclosure, a method of a user equipment in a wireless communication system, includes: receiving, from a base station, configuration information including at least one of a pre-condition, a trigger condition, and a cancel condition for a handover from the base station to a satellite; receiving a first reference signal from the base station and a second reference signal from the satellite, respectively; measuring Reference Signal Received Power (RSRP) of each of the first reference signal and the second reference signal; and transmitting a first measurement report to the base station, based on a determination that the trigger condition related to the first reference signal and the pre-condition related to the second reference signal are satisfied.

According to another aspect of the disclosure, a method of a user equipment in a wireless communication system, includes: receiving, from a satellite, configuration information including at least one of a trigger condition and a cancel condition for a handover from the satellite to a base station; receiving a reference signal from the base station; measuring RSRP of the received reference signal; and transmitting a first measurement report to the satellite based on a determination that the trigger condition related to the received reference signal is satisfied. The configuration information includes at least one of an RSRP threshold of the received reference signal and a Hys parameter for the received reference signal.

According to another aspect of the disclosure, a method of a user equipment in a wireless communication system, includes: receiving, from a satellite, configuration information including at least one of a trigger condition and a cancel condition for a handover from the satellite to a base station; receiving a reference signal from the base station; measuring RSRP of the received reference signal; and transmitting a first measurement report to the satellite based on a determination that the trigger condition related to the received reference signal is satisfied. The configuration information includes at least one of an RSRP threshold of the received reference signal and a Hys parameter for the received reference signal.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a wireless communication system according to an embodiment;

FIG. 1B illustrates a communication procedure between a serving cell and User Equipment (UE), according to an embodiment;

FIG. 2A illustrates a handover scenario according to an embodiment;

FIG. 2B illustrates an example of Reference Signal Received Power (RSRP) over time of each of a Terrestrial Network (TN) cell and a Non-Terrestrial Network (NTN) cell in the handover scenario of FIG. 2A;

FIG. 3A illustrates a handover scenario according to an embodiment;

FIG. 3B illustrates an example of RSRP over time of each of a TN cell and an NTN cell in the handover scenario of FIG. 3A;

FIG. 4A illustrates a handover scenario according to an embodiment;

FIG. 4B illustrates an example of RSRP over time of each of a TN cell and an NTN cell in the handover scenario of FIG. 4A;

FIG. 4C illustrates an operation procedure of UE according to an embodiment;

FIG. 5A illustrates a handover scenario according to an embodiment;

FIG. 5B illustrates an example of RSRP over time of a TN cell in the handover scenario of FIG. 5A;

FIG. 5C illustrates an operation procedure of UE according to an embodiment;

FIG. 6A illustrates a handover scenario according to an embodiment;

FIG. 6B illustrates an example of RSRP over time of an NTN cell in the handover scenario of FIG. 6A;

FIG. 6C illustrates an operation procedure of UE according to an embodiment;

FIG. 7A illustrates a handover scenario according to an embodiment;

FIG. 7B illustrates an example of RSRP over time of each of a TN cell and an NTN cell in the handover scenario of FIG. 7A;

FIG. 8 illustrates an operation procedure of a base station or a satellite, according to an embodiment;

FIG. 9 is a block diagram illustrating a wireless communication apparatus according to an embodiment; and

FIG. 10 is a block diagram illustrating an electronic device according to an embodiment.

### DETAILED DESCRIPTION

A base station may communicate with a wireless communication apparatus, may be a subject for allocating communication network resources to the wireless communication apparatus, and may be at least one of a cell, a Base Station (BS), NodeB (NB), eNodB (eNB), a Next Generation Radio Access Network (NG RAN), a radio access unit, a base station controller, a node on the network, and gNodeB (gNB).

The wireless communication apparatus may communicate with a base station or another wireless communication apparatus, and may be referred to as a node, a User Equipment (UE), a Next Generation UE (NG UE), a Mobile Station (MS), a Mobile Equipment (ME), a device, a terminal, or the like.

Also, the wireless communication apparatus may include at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, medical equipment, a camera, and a wearable device. In addition, the wireless communication apparatus may include at least one of a television, a Digital Video Disk (DVD) player, an audio apparatus, a refrigerator, an air conditioner, a vacuum cleaner, an oven, a microwave, a washing machine, an air purifier, a set-top box, a home automation control panel, a media box (e.g., Samsung HomeSync™, AppleTV™, or Google TV™), a game console (e.g., Xbox™ or PlayStation), electronic dictionary, an electronic key, a camcorder, and an electronic picture frame.

In addition, the wireless communication apparatus may include at least one of various types of medical equipment (e.g., various types of portable medical measurement devices (a blood glucose meter, a heart rate meter, a blood pressure meter, a body temperature meter, and the like), Magnetic Resonance Angiography (MRA), Magnetic Resonance Imaging (MRI), Computed Tomography (CT), a photographic device, an ultrasonic device, and the like), a navigation system, a Global Navigation Satellite System (GNSS), an Event Data Recorder (EDR), a flight data recorder, automotive infotainment equipment, electronic equipment for a ship (e.g., a navigation system for a ship, a gyrocompass, and the like), avionics, security equipment, a vehicle head unit, an industrial or home robot, a drone, an ATM of a financial institution, Point Of Sales (POS) in a store, and an Internet of Things (IoT) apparatus (e.g., a light bulb, various types of sensors, a sprinkler apparatus, a fire alarm, a thermostat, street lights, a toaster, exercise equipment, a hot water tank, a heater, a boiler, or the like). In addition, the wireless communication apparatus may include various types of multimedia systems capable of performing communication functions. Hereinafter, embodiments will be described in detail with reference to the accompanying drawings.

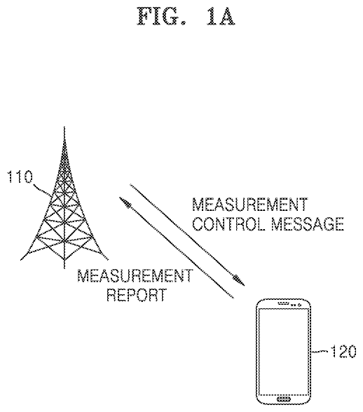

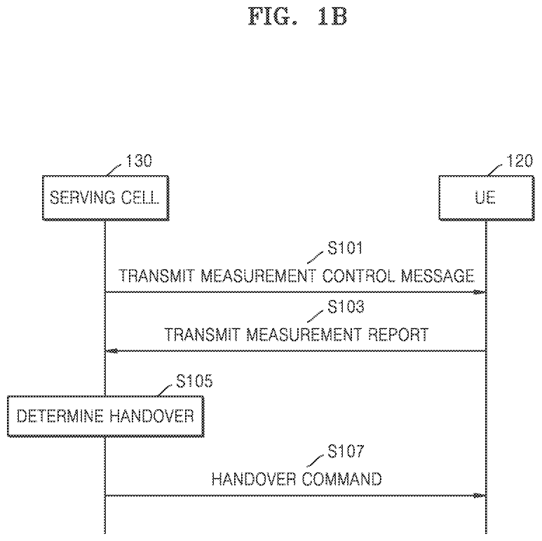

FIG. 1A illustrates a wireless communication system according to an embodiment. In FIG. 1A, the wireless communication system may include a UE 120 and a base station 110. FIG. 1A illustrates that the wireless communication system includes only one base station 110 and one UE 120. However, the illustration is only an embodiment, and thus, the wireless communication system is not limited thereto, and may be implemented to include various numbers of base stations and UEs.

The base station 110 may be connected to the UE 120 through a wireless channel to provide various types of communication services. The base station 110 may provide a service through a shared channel for all user traffic, and may perform scheduling by collecting state information, such as a buffer state, an available transmit power state, and a channel state of the UE 120. The wireless communication system may support beamforming technology by using Orthogonal Frequency Division Multiplexing (OFDM) as radio access technology. In addition, the wireless communication system may support an Adaptive Modulation & Coding (AMC) scheme for determining a modulation scheme and a channel coding rate according to the channel state of the UE 120.

In addition, the wireless communication system may transmit or receive signals by using a wide frequency band present in a frequency band that is greater than or equal to 6 GHz. For example, the wireless communication system may increase a data transmission rate by using a millimeter wave band, such as 28 GHz band or 60 GHz band. Here, the millimeter wave band has a relatively large signal attenuation magnitude per distance, and thus, the wireless communication system may support transmission and reception, which are based on a directional beam generated by using multiple antennas, to secure coverage. The wireless communication system may be a system that supports Multiple Input Multiple Output (MIMO), and accordingly, the base station 110 and the UE 120 may support beamforming technology. The beamforming technology may be divided into digital beamforming, analog beamforming, hybrid beamforming, and the like.

In FIG. 1A, the base station 110 may transmit a measurement control message to the UE 120. The measurement control message may include information related to a handover. The UE 120 may receive a signal from the base station 110 and another base station or a satellite. When a handover condition is satisfied, the UE 120 may transmit a measurement report to the base station 110.

FIG. 1B illustrates a communication procedure between a serving cell and a UE, according to an embodiment. In FIG. 1B, in operation S101, a serving cell 130 may transmit a measurement control message to UE 120. The serving cell 130 may be a cell to which the UE 120 is connected. The UE 120 may communicate with the base station 110 (on the ground) or a satellite base station. The measurement control message may include one or more handover events, one or more conditions of the handover events, a threshold related to handover, or a parameter related to the handover. The UE 120 may receive the measurement control message from the serving cell 130, and may identify a handover event and a condition of the handover event.

The UE 120 may receive a reference signal from the serving cell 130, and may measure, for the received reference signal, at least one of (i) Reference Signal Received Power (RSRP), (ii) Reference Signal Received Quality (RSRQ), (iii) a Received Signal Strength Indicator (RSSI), and (iv) a Signal To Interference Plus Noise Ratio (SINR). In addition, the UE 120 may receive a reference signal from a neighbor cell, and may measure, for the received reference signal, at least one of RSRP, RSRQ, an RSSI, and an SINR. The reference signal may be any one of a Synchronization Signal Block (SSB) and a Channel State Information-Reference Signal (CSI-RS).

In operation S103, when a measurement value for the reference signal satisfies the condition for the handover event, the UE 120 may transmit a measurement report including a measurement result to the serving cell 130. The serving cell 130 may transmit the measurement report to a core network or a target cell to be handed over.

In operation S105, any one of the serving cell 130, the target cell, and the core network may determine a handover. When the target cell or the core network determines the handover, the target cell or the core network may transmit information regarding the determined handover to the serving cell 130.

In operation S107, the serving cell 130 may transmit a handover command to the UE 120.

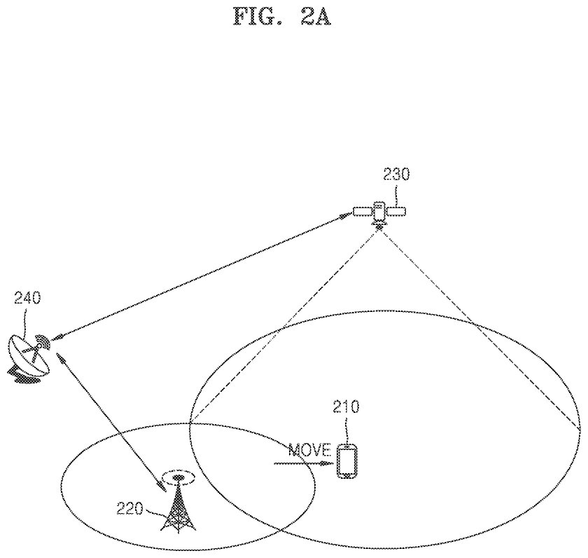

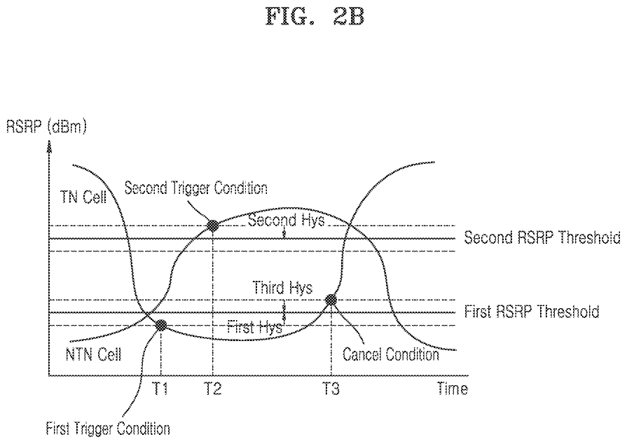

FIG. 2A illustrates a handover scenario according to an embodiment. In the disclosure, an area served by a terrestrial base station is referred to as a terrestrial network (TN) cell, and an area served by a satellite base station is referred to as a non-terrestrial (NTN) cell. The TN cell and the NTN cell may have different cell sizes, data transmission rates, bandwidths, and the like. Accordingly, the above-described characteristics need to be considered for a handover in an area in which the TN cell and the NTN cell overlap.

In FIG. 2A, a coverage of a cell for a base station 220 (on the ground) is less than a coverage of a cell for a satellite 230. In other words, a coverage of the TN cell is less than a coverage of a satellite cell. A gateway 240 may simultaneously support the TN cell and the NTN cell. The gateway 240 may support handover between the TN cell and the NTN cell. UE 210 may move to an NTN cell area from an area in which the TN cell and the NTN cell overlap each other. Accordingly, the UE 210 needs to hand over from the TN cell to the NTN cell.

FIG. 2B illustrates an example of RSRP over time of each of the TN cell and the NTN cell in the handover scenario of FIG. 2A. FIG. 2B illustrates RSRP of each of the TN cell and the NTN cell when the UE 210 moves to the NTN cell area from an area in which the TN cell and the NTN cell overlap. The UE 210 is connected to the TN cell served by the base station 220. In addition, the UE 210 may be located in the NTN cell area served by the satellite 230.

A ‘first handover’ may be based on an intensity of signal power, from the TN cell to the NTN cell. The UE 210 may receive, from the base station 220, a measurement control message including information regarding the first handover. The measurement control message may include at least one of a ‘First Trigger Condition,’ a ‘Second Trigger Condition,’ and a ‘Cancel Condition’ for the first handover, which are shown in FIG. 2B.

Here, the First Trigger Condition is related to a first reference signal received by the UE 210 from the base station 220. The Second Trigger Condition is related to a second reference signal received from the satellite 230. The Cancel Condition is related to the first reference signal received by the UE 210 from the base station 220.

The measurement control message may include a first RSRP threshold and a first hysteresis (Hys) parameter for the First Trigger Condition. The measurement control message may include a second RSRP threshold and a second Hys parameter for the Second Trigger Condition. The measurement control message may include the first RSRP threshold and a third Hys parameter for the Cancel Condition.

The UE 210 may receive the first reference signal from the base station 220, and may measure RSRP for the received first reference signal. The First Trigger Condition for the RSRP of the first reference signal may be expressed as in Equation 1 below.

RSRP of TNcell<first RSRP threshold−first Hys [Equation 1]

In Equation 1, the RSRP of the TN cell may be a result of measuring the first reference signal received by the UE 210 from the base station 220. The first RSRP threshold may be a threshold of the RSRP of the TN cell for triggering the first handover or canceling the trigger of the first handover. The first Hys may be a Hys parameter for the trigger of the first handover. The Hys parameter may support stable communication by reducing the number of occurrences of handover.

The UE 210 may receive the second reference signal from the satellite 230, and may measure RSRP for the received second reference signal. The Second Trigger Condition for the RSRP of the second reference signal may be expressed as in Equation 2 below.

RSRP of NTNcell>second RSRP threshold+second Hys [Equation 2]

In Equation 2, the RSRP of the NTN cell may be a result of measuring the second reference signal received by the UE 210 from the satellite 230. The second RSRP threshold may be an RSRP threshold of the NTN cell for triggering the first handover. The second Hys may be a Hys parameter for the trigger of the first handover.

The UE 210 may transmit a measurement report to the base station 220 when the RSRP of the TN cell satisfies the First Trigger Condition and the RSRP of the NTN cell satisfies the Second Trigger Condition. Accordingly, a handover procedure may start.

The Cancel Condition may be expressed as in Equation 3 below.

RSRP of TNcell>first RSRP threshold+third Hys [Equation 3]

In Equation 3, the RSRP of the TN cell may be a result of measuring the first reference signal received by the UE 210 from the base station 220. The first RSRP threshold may be a threshold of the RSRP of the TN cell for triggering the first handover or canceling the trigger of the first handover. The third Hys may be a Hys parameter for the cancellation of the first handover.

In FIG. 2B, the First Trigger Condition may started at T1. The Second Trigger Condition may start at T2. The Cancel Condition may start at T3. An example in which the start time T1 of the First Trigger Condition precedes the start time T2 of the Second Trigger Condition is described, but the start time T1 of the First Trigger Condition may follow the start time T2 of the Second Trigger Condition, and is not limited to the above embodiment.

In the First Trigger Condition and the Cancel Condition, the magnitude of Hys may be the same. For example, the first Hys and the third Hys may be the same as each other.

Meanwhile, in the First Trigger Condition and the Cancel Condition, Hys may be different. For example, the first Hys and the third Hys may be different from each other.

The TN cell and the NTN cell have different sizes and characteristics.

Accordingly, the first RSRP threshold and the second RSRP threshold may be different from each other. In addition, the first Hys parameter and the second Hys parameter may be different from each other.

When the RSRP of the TN cell, which is a serving cell, is not recovered and a first handover procedure to the NTN cell is completed, the UE 210 may be provided with a service in the NTN cell. When the Cancel Condition is satisfied by recovering the RSRP of the TN cell before the first handover procedure is completed, the UE 210 may transmit a measurement report to the base station 220. Accordingly, the handover procedure may be canceled. Accordingly, the UE 210 may be continuously provided with a service in the TN cell.

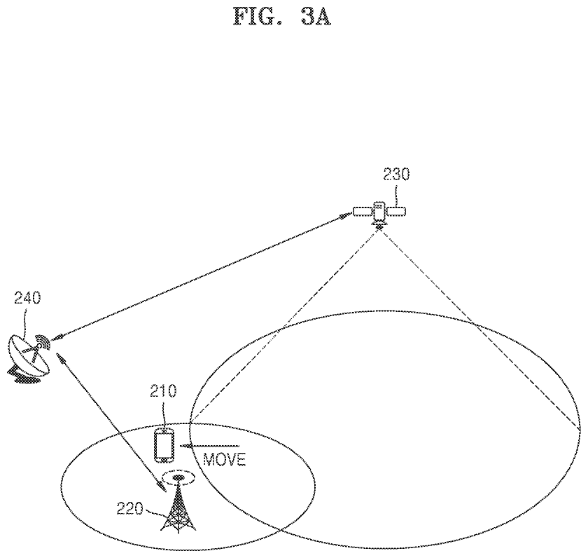

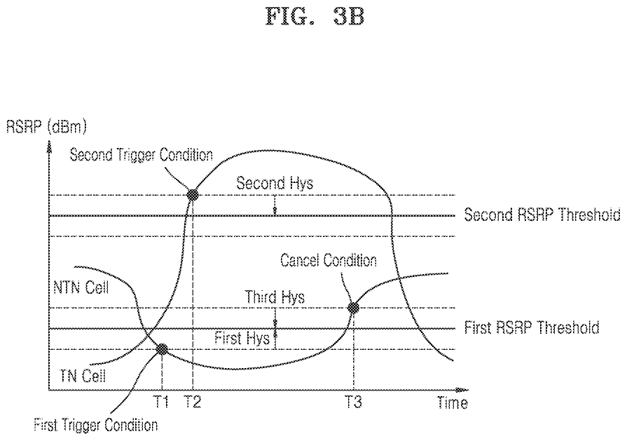

FIG. 3A illustrates a handover scenario according to an embodiment. In FIG. 3A, UE 210 may move to a TN cell area from an area in which the TN cell and an NTN cell overlap each other. Accordingly, the UE 210 needs to hand over from the NTN cell to the TN cell. In other words, when the NTN cell is a serving cell, the UE 210 needs to hand over to the TN cell.

FIG. 3B illustrates an example of RSRP over time of each of the TN cell and the NTN cell in the handover scenario of FIG. 3A. FIG. 3B illustrates RSRP of each of the TN cell and the NTN cell when the UE 210 moves to the TN cell area from an area in which the TN cell and the NTN cell overlap. The UE 210 is connected to the TN cell served by the satellite 230. In addition, the UE 210 may be located in the TN cell area served by the base station 220.

A second handover may be based on an intensity of signal power, from the NTN cell to the TN cell. The UE 210 may receive, from the satellite 230, a measurement control message including information regarding the second handover. The measurement control message may include at least one of a First Trigger Condition, a Second Trigger Condition, and a Cancel Condition for the second handover.

Here, the First Trigger Condition and the Cancel Condition are related to a first reference signal received by the UE 210 from the satellite 230. The Second Trigger Condition is related to a second reference signal received from the base station 220.

The measurement control message may include a first RSRP threshold and a first Hys parameter for the first Trigger Condition. The measurement control message may include a second RSRP threshold and a second Hys parameter for the Second Trigger Condition. The measurement control message may include the first RSRP threshold and a third Hys parameter for the Cancel Condition.

The UE 210 may receive the first reference signal from the satellite 230, and may measure RSRP for the received first reference signal. The First Trigger Condition for the RSRP of the first reference signal may be expressed as in Equation 4 below.

RSRP of NTNcell<first RSRP threshold−first Hys [Equation 4]

In Equation 4, the RSRP of the NTN cell may be a result of measuring the first reference signal received by the UE 210 from the satellite 230. The first RSRP threshold may be a threshold of the RSRP of the NTN cell for triggering the second handover or canceling the trigger of the second handover. The first Hys may be a Hys parameter for the trigger of the second handover.

The UE 210 may receive the second reference signal from the base station 220, and may measure RSRP for the received second reference signal. The Second Trigger Condition for the RSRP of the second reference signal may be expressed as in Equation 5 below.

RSRP of TNcell>second RSRP threshold+second Hys [Equation 5]

In Equation 5, the RSRP of the TN cell may be a result of measuring the second reference signal received by the UE 210 from the base station 220. The second RSRP threshold may be a threshold of the RSRP of the TN cell for triggering the second handover. The second Hys may be a Hys parameter for the trigger of the second handover.

The UE 210 may transmit a measurement report to the satellite 230 when the RSRP of the NTN cell satisfies the First Trigger Condition and the RSRP of the TN cell satisfies the Second Trigger Condition. Accordingly, a handover procedure may start.

The Cancel Condition may be expressed as in Equation 6 below.

RSRP of NTN cell>first RSRP threshold+third Hys [Equation 6]

In Equation 6, the RSRP of the NTN cell may be a result of measuring the first reference signal received by the UE 210 from the satellite 230. The third RSRP threshold may be a threshold of the RSRP of the NTN cell for triggering the second handover or canceling the trigger of the second handover. The third Hys may be a Hys parameter for the cancellation of the second handover.

In FIG. 3B, the First Trigger Condition may start at T1. The Second Trigger Condition may start at T2. The Cancel Condition may start at T3. An example in which the start time T1 of the First Trigger Condition precedes the start time T2 of the Second Trigger Condition is described, but the start time T1 of the First Trigger Condition may follow the start time T2 of the Second Trigger Condition, and is not limited to the above embodiment.

When the RSRP of the NTN cell, which is a serving cell, is not recovered and a second handover procedure to the TN cell is completed, the UE 210 may be provided with a service in the TN cell. When the Cancel Condition is satisfied by recovering the RSRP of the NTN cell before the second handover procedure is completed, the UE 210 may transmit a measurement report to the satellite 230. Accordingly, the handover procedure may be canceled. Accordingly, the UE 210 may be continuously provided with a service in the NTN cell.

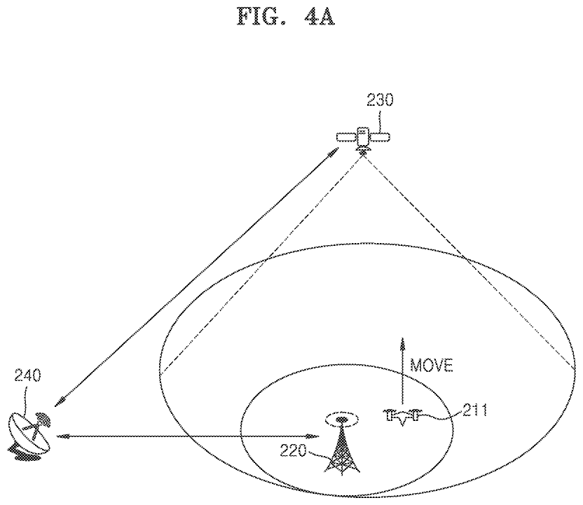

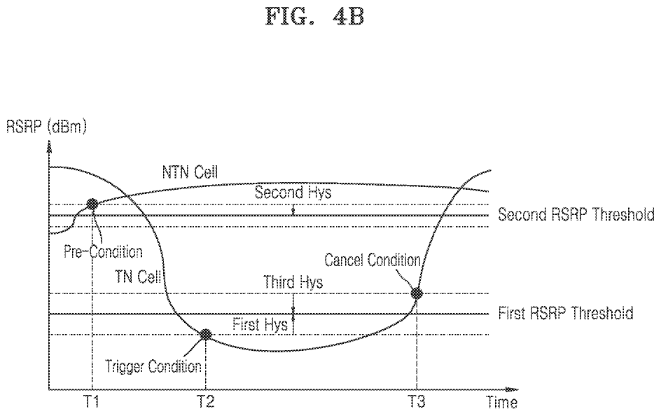

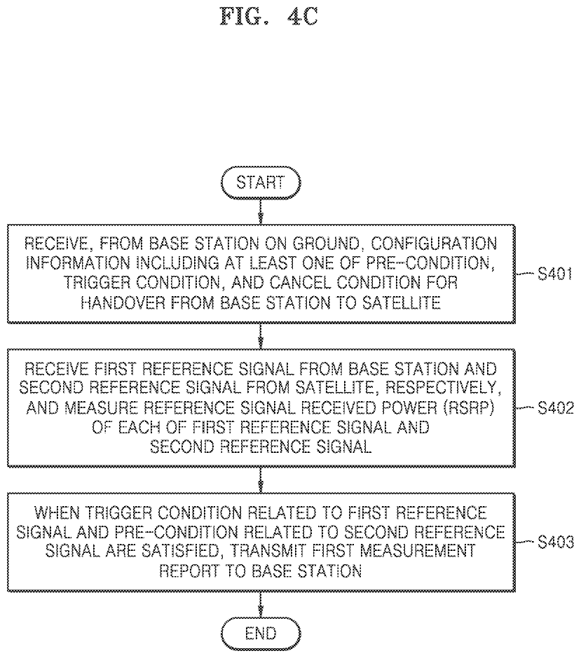

FIG. 4A illustrates a handover scenario according to an embodiment.

In FIG. 4A, a coverage of a cell for the base station 220 (on the ground) is less than a coverage of a cell for the satellite 230. In other words, a coverage of a TN cell is less than a coverage of a satellite cell. In addition, the coverage of the cell for the base station 220 is included in the coverage of the cell for the satellite 230. In one embodiment, a coverage of a TN including one or more base stations may be greater than a coverage of an NTN.

A UE 211 may have a flight capability. For example, the UE 211 may be a drone or an airplane. The UE 211 may move to the NTN cell area from an area in which the TN cell and the NTN cell overlap. For example, the UE 211 may move vertically from the ground to be closer to the satellite 230. Accordingly, the UE 211 needs to hand over from the TN cell to the NTN cell.

FIG. 4B illustrates an example of RSRP over time of each of a TN cell and an NTN cell in the handover scenario of FIG. 4A. FIG. 4B illustrates RSRP for each of a TN cell and an NTN cell when the UE 211 moves to an NTN cell area from an area in which the TN cell and the NTN cell overlap each other. The UE 211 is connected to a TN cell served by the base station 220. In addition, the UE 211 may be located in an NTN cell area served by the satellite 230. In FIG. 4B, RSRP of the NTN cell has a less degree of change than RSRP of the TN cell.

A third handover may be based on an TN, from the TN to an NTN. The UE 211 may receive, from the base station 220, a measurement control message including information regarding the third handover. The measurement control message may include at least one of a Trigger Condition, a Cancel Condition, and a Pre-Condition for the third handover.

Here, the Trigger Condition and the Cancel Condition are related to a first reference signal received by the UE 211 from the base station 220. The Pre-Condition is related to a second reference signal received by the UE 211 from the satellite 230.

The measurement control message may include a first RSRP threshold and a first Hys parameter for the Trigger Condition. The measurement control message may include the first RSRP threshold and a third Hys parameter for the Cancel Condition. The measurement control message may include a second RSRP threshold and a second Hys parameter for the Pre-Condition.

The UE 211 may receive the first reference signal from the base station 220, and may measure RSRP for the received first reference signal. The Trigger Condition for the RSRP of the first reference signal may be expressed as in Equation 7 below.

RSRP of TN cell<first RSRP threshold−first Hys [Equation 7]

In Equation 7, the RSRP of the TN cell may be a result of measuring the first reference signal received by the UE 211 from the base station 220. The first RSRP threshold may be a threshold of the RSRP of the TN cell for triggering the third handover or canceling the trigger of the third handover. The first Hys may be a Hys parameter for the trigger of the third handover.

The UE 211 may receive the second reference signal from the satellite 230, and may measure RSRP for the received second reference signal. The Pre-Condition for the RSRP of the second reference signal may be expressed as in Equation 8 below.

RSRP of NTN cell>second RSRP threshold+second Hys [Equation 8]

In Equation 8, the RSRP of the NTN cell may be a result of measuring the second reference signal received by the UE 211 from the satellite 230. The second RSRP threshold may be a threshold (a minimum value) of RSRP at which the UE 211 may identify the second reference signal transmitted by the satellite 230. In other words, the second RSRP threshold may be a minimum value at which the RSRP of the second reference signal may be measured. The second Hys may be a Hys parameter for the Pre-Condition for the third handover. The second RSRP threshold (the minimum value) of the third handover may be less than the second RSRP of the first handover.

The UE 211 may transmit a measurement report to the base station 220 when the RSRP of the TN cell satisfies the Trigger Condition and the RSRP of the NTN cell satisfies the Pre-Condition. Accordingly, a handover procedure may start.

The Cancel Condition may be expressed as in Equation 9 below.

RSRP of TN cell>first RSRP threshold+third Hys [Equation 9]

In Equation 9, the RSRP of the TN cell may be a result of measuring the first reference signal received by the UE 211 from the base station 220. The first RSRP threshold may be a threshold of the RSRP of the TN cell for triggering the third handover or canceling the trigger of the third handover. The third Hys may be a Hys parameter for the cancellation of the third handover.

The TN cell and the NTN cell have different sizes and characteristics. Accordingly, the first RSRP threshold and the second RSRP threshold may be different from each other. In addition, the first Hys parameter and the second Hys parameter may be different from each other.

In FIG. 4B, the Pre-Condition may start at T1. The Trigger Condition may start at T2. The Cancel Condition may start at T3. T1 may precede T2.

When the RSRP of the TN cell, which is a serving cell, is not recovered and a third handover procedure to the NTN cell is completed, the UE 211 may be provided with a service in the NTN cell. When the Cancel Condition is satisfied by recovering the RSRP of the TN cell before the third handover procedure is completed, the UE 211 may transmit the measurement report to the base station 220. Accordingly, the handover procedure may be canceled. Accordingly, the UE 211 may be continuously provided with the service in the TN cell.

FIG. 4C illustrates an operation procedure of UE according to an embodiment. FIG. 4C illustrates an example of an operation procedure of the above-described third handover, which is based on a TN, from a TN to an NTN.

In operation S401, the UE 211 may receive, from the base station 220 on the ground, configuration information including at least one of a pre-condition, a Trigger Condition, and a Cancel Condition for a handover from the base station 220 to the satellite 230.

In operation S402, the UE 211 may receive a first reference signal from the base station 220 and a second reference signal from the satellite 230, respectively, and may measure RSRP of each of the first reference signal and the second reference signal. The configuration information may include at least one of a first RSRP threshold of the first reference signal, a first Hys parameter for the first reference signal, a second RSRP threshold of the second reference signal, a second Hys parameter for the second reference signal, and a third Hys parameter for the first reference signal.

The first RSRP threshold and the second RSRP threshold may be different from each other, and the first Hys parameter and the second Hys parameter may be different from each other. The Trigger Condition may be a condition in which the RSRP of the first reference signal is less than a value obtained by subtracting the first Hys parameter from the first RSRP threshold. The Pre-Condition may be a condition in which the RSRP of the second reference signal is greater than a sum of the second RSRP threshold and the second Hys parameter. The second RSRP threshold may be a minimum value at which the RSRP of the second reference signal may be measured.

In operation S403, when the Trigger Condition related to the first reference signal and the Pre-Condition related to the second reference signal are satisfied, the UE 211 may transmit a first measurement report to the base station 220. When the Cancel Condition is satisfied after transmitting the first measurement report and before completing the handover, the UE 211 may transmit a second measurement report to the base station 220. When the handover is already completed after transmitting the first measurement report, the UE 211 may not transmit the second measurement report even when the Cancel Condition is satisfied.

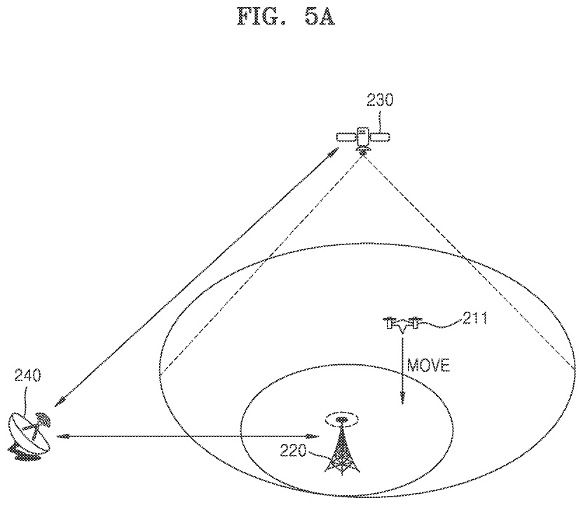

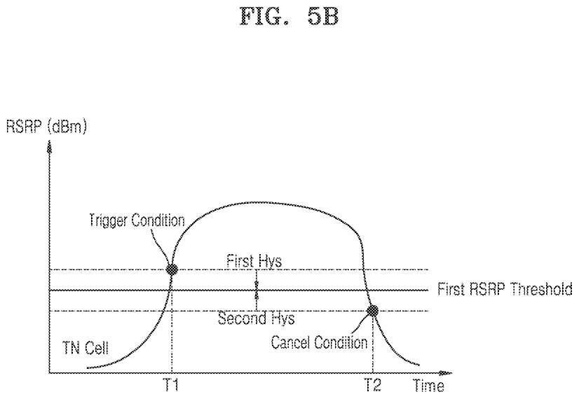

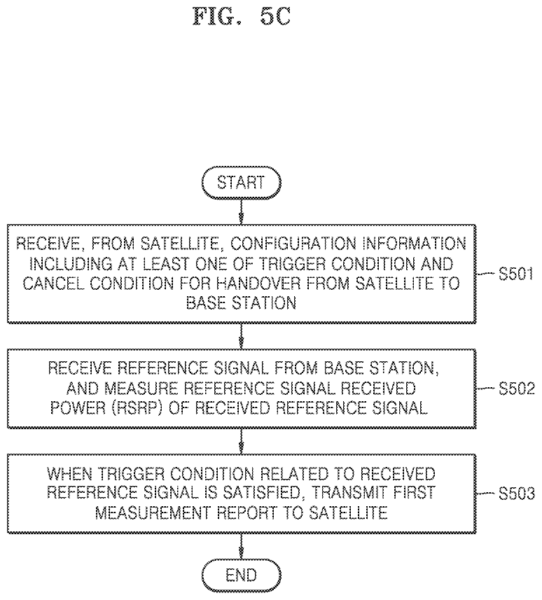

FIG. 5A illustrates a handover scenario according to an embodiment. In FIG. 5A, a coverage of a cell for the base station 220 is included in a coverage of a cell for the satellite 230. UE 211 may have a flight capability. For example, the UE 211 may a drone or an airplane. The UE 211 may move from the NTN cell area to an area in which the TN cell and an NTN cell overlap. For example, the UE 211 may move vertically from the upper air to be closer to the base station 220. Accordingly, the UE 211 needs to hand over from the NTN cell to the TN cell.

FIG. 5B illustrates an example of RSRP over time of a TN cell in the handover scenario of FIG. 5A. FIG. 5B illustrates RSRP of a TN cell when the UE 211 moves from an NTN cell area to an area in which the TN cell and an NTN cell overlap each other. The UE 210 is connected to an NTN cell served by the satellite 230. In addition, the UE 211 may move to an NTN cell area served by the base station 220. RSRP of the NTN cell may have a less degree of change than RSRP of the TN cell.

A fourth handover may be based on an TN, from an NTN to the TN. The UE 211 may receive, from the satellite 230, a measurement control message including information regarding the fourth handover. The measurement control message may include at least one of a Trigger Condition and a Cancel Condition for the fourth handover.

Here, the Trigger Condition is related to a first reference signal received by the UE 211 from the base station 220. The Cancel Condition is related to the first reference signal received by the UE 211 from the base station 220.

The measurement control message may include a first RSRP threshold and a first Hys parameter for the Trigger Condition. The measurement control message may include the first RSRP threshold and a second Hys parameter for the Cancel Condition.

The UE 211 may receive the first reference signal from the base station 220, and may measure RSRP for the received first reference signal. The Trigger Condition for the RSRP of the first reference signal may be expressed as in Equation 10 below.

RSRP of TN cell>first RSRP threshold+third Hys [Equation 10]

In Equation 10, the RSRP of the TN cell may be a result of measuring the first reference signal received by the UE 211 from the base station 220. The first RSRP threshold may be a threshold of the RSRP of the TN cell for triggering the fourth handover or canceling the trigger of the fourth handover. The first Hys may be a Hys parameter for the trigger of the fourth handover.

When the RSRP of the TN cell satisfies the Trigger Condition, the UE 211 may transmit a measurement report to the satellite 230. Accordingly, a handover procedure may start.

The Cancel Condition may be expressed as in Equation 11 below.

RSRP of TN cell<first RSRP threshold−second Hys [Equation 11]

In Equation 11, the RSRP of the TN cell may be a result of measuring the first reference signal received by the UE 211 from the base station 220. The first RSRP threshold may be a threshold of the RSRP of the TN cell for triggering the fourth handover or canceling the trigger of the fourth handover. The second Hys may be a Hys parameter for the cancellation of the fourth handover. The first Hys and the second Hys may have the same size. The first Hys and the second Hys may be different from each other.

In FIG. 5B, the Trigger Condition may start at T1. The Cancel Condition may start at T2.

When the RSRP of the TN cell does not satisfy the Cancel Condition and a fourth handover procedure to the TN cell is completed, the UE 211 may be provided with a service in the TN cell. When the RSRP of the TN cell satisfies the Cancel Condition before the fourth handover procedure is completed, the UE 211 may transmit the measurement report to the base station 220. Accordingly, the handover procedure may be canceled. Accordingly, the UE 211 may be continuously provided with a service in the NTN cell.

FIG. 5C illustrates an operation procedure of UE according to an embodiment. FIG. 5C illustrates an example of an operation procedure of the above-described fourth handover, which is based on a TN, from an NTN to the TN.

In operation S501, the UE 211 may receive, from the satellite 230, configuration information including at least one of a Trigger Condition and a Cancel Condition for a handover from the satellite 230 to the base station 220.

In operation S502, the UE 211 may receive a reference signal from the base station 220, and may measure RSRP of the received reference signal. The configuration information may include at least one of an RSRP threshold of the received reference signal and a Hys parameter for the received reference signal. The Trigger Condition may be a condition in which the RSRP of the received reference signal is greater than a sum of the RSRP threshold and the Hys parameter. The Cancel Condition may be a condition in which the RSRP of the received reference signal is less than a value obtained by subtracting the Hys parameter from the RSRP threshold.

In operation S503, when the Trigger Condition related to the received reference signal is satisfied, the UE 211 may transmit a first measurement report to the satellite 230. When the Cancel Condition is satisfied after transmitting the first measurement report and before completing the handover, the UE 211 may transmit a second measurement report to the satellite 230. When the handover is already completed after transmitting the first measurement report, the UE 211 may not transmit the second measurement report even when the Cancel Condition is satisfied.

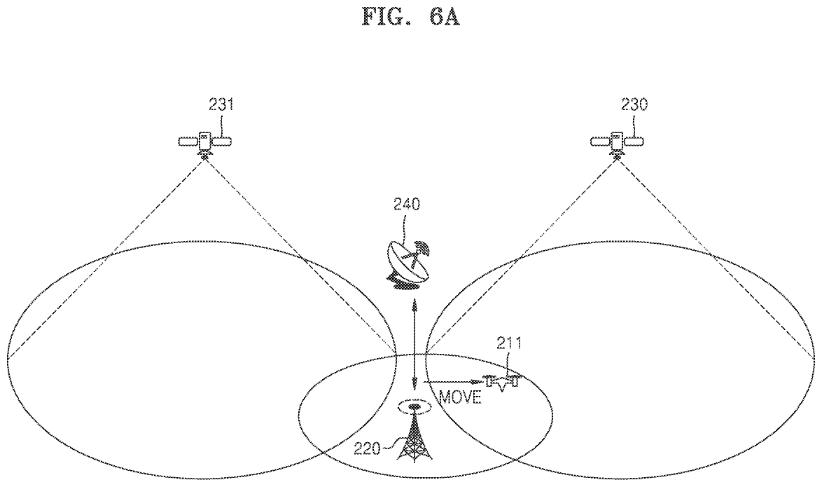

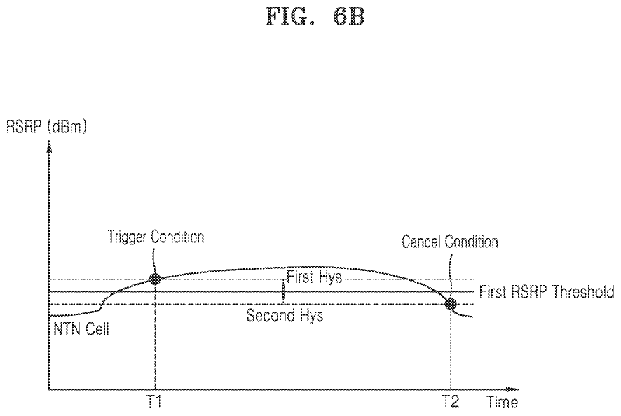

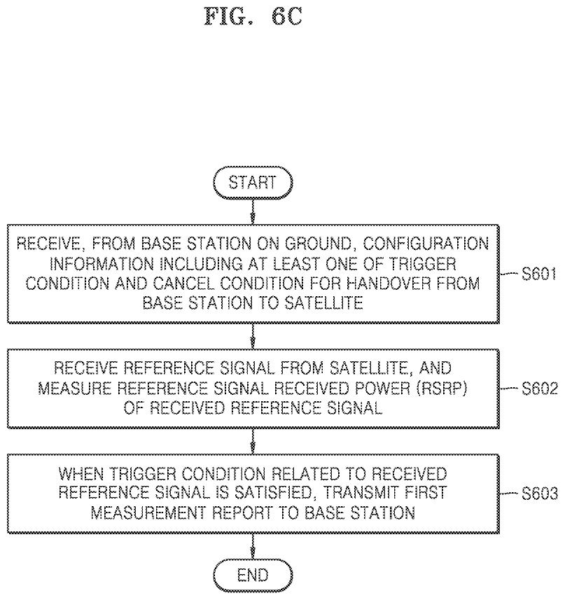

FIG. 6A illustrates a handover scenario according to an embodiment. In FIG. 6A, a coverage of a cell for the satellite 230 is greater than a coverage of a cell for the base station 220. A cell for the satellite 231 does not overlap the cell for the satellite 230. When the cell for satellite 230 and the cell for satellite 231 overlap within a cell for base station 220, the UE 211 does not need to hand over from the NTN cell to the TN cell.

The UE 211 may have a flight capability. For example, the UE 211 may be a drone or an airplane. The UE 211 may move from an area in which only the TN cell is served to an overlapping area between the TN cell and the NTN cell. For example, the UE 211 may move, at a high speed, from the area in which only the TN cell is served to the overlapping area between the TN cell and the NTN cell. Accordingly, the UE 211 needs to hand over from the TN cell to the NTN cell.

FIG. 6B illustrates an example of RSRP over time of an NTN cell in the handover scenario of FIG. 6A. FIG. 6B illustrates RSRP of the NTN cell when the UE 211 moves from a TN cell area to an area in which the TN cell and the NTN cell overlap. In other words, the UE 211 may be connected to the TN cell, and may move to the area in which the TN cell and the NTN cell overlap each other. The RSRP of the NTN cell may have a less degree of change than RSRP of the TN cell.

A fifth handover may be based on an NTN, from a TN to the NTN. The UE 211 may receive, from the base station 220, a measurement control message including information regarding the fifth handover. The measurement control message may include at least one of a Trigger Condition and a Cancel Condition for the fifth handover.

Here, the Trigger Condition and the Cancel Condition are related to a first reference signal received by the UE 210 from the satellite 230. The measurement control message may include a first RSRP threshold and a first Hys parameter for the Trigger Condition. The measurement control message may include the first RSRP threshold and a second Hys parameter for the Cancel Condition.

The UE 211 may receive the first reference signal from the satellite 230, and may measure RSRP for the received first reference signal. The Trigger Condition for the RSRP of the first reference signal may be expressed as in Equation 12 below.

RSRP of NTN cell>first RSRP threshold+first Hys [Equation 12]

In Equation 12, the RSRP of the NTN cell may be a result of measuring the first reference signal received by the UE 211 from the satellite 230. The first RSRP threshold may be a threshold of the RSRP of the NTN cell for triggering the fifth handover or canceling the trigger of the fifth handover. The first Hys may be a Hys parameter for the trigger of the fifth handover.

When the RSRP of the NTN cell satisfies the Trigger Condition, the UE 211 may transmit a measurement report to the base station 220. Accordingly, a handover procedure may start.

The Cancel Condition may be expressed as in Equation 13 below.

RSRP of NTN cell<first RSRP threshold−second Hys [Equation 13]

In Equation 13, the RSRP of the NTN cell may be a result of measuring the first reference signal received by the UE 211 from the satellite 230. The first RSRP threshold may be a threshold of the RSRP of the NTN cell for triggering the fifth handover or canceling the trigger of the fifth handover. The second Hys may be a Hys parameter for the cancellation of the fifth handover.

In FIG. 6B, the Trigger Condition may start at T1. The Cancel Condition may start at T2. When a fifth handover procedure to the NTN cell is completed while the RSRP of the NTN cell does not satisfy the Cancel Condition, the UE 211 may be provided with a service in the NTN cell. When the RSRP of the NTN cell satisfies the Cancel Condition before the fifth handover procedure is completed, the UE 211 may transmit the measurement report to the base station 220. Accordingly, the handover procedure may be canceled. Accordingly, the UE 211 may be continuously provided with a service in the TN cell. For example, when the UE 211 moves back to the area in which only the TN cell is served, the Cancel Condition may be satisfied, and the UE 211 may be continuously provided with the service in the TN cell.

FIG. 6C illustrates an operation procedure of UE according to an embodiment. In FIG. 6C, in operation S601, the UE 211 may receive, from the base station 220 (on the ground), configuration information including at least one of a Trigger Condition and a Cancel Condition for a handover from the base station 220 to the satellite 230.

In operation S602, the UE 211 may receive a reference signal from the satellite 230, and may measure RSRP of the received reference signal. The configuration information may include at least one of an RSRP threshold of the received reference signal and a Hys parameter for the received reference signal. The Trigger Condition may be a condition in which the RSRP of the received reference signal is greater than a sum of the RSRP threshold and the Hys parameter. The Cancel Condition may be a condition in which the RSRP of the received reference signal is less than a value obtained by subtracting the Hys parameter from the RSRP threshold.

In operation S603, when the Trigger Condition related to the received reference signal is satisfied, the UE 211 may transmit a first measurement report to the base station 220. When the Cancel Condition is satisfied after transmitting the first measurement report and before completing the handover, the UE 211 may transmit a second measurement report to the base station 220.

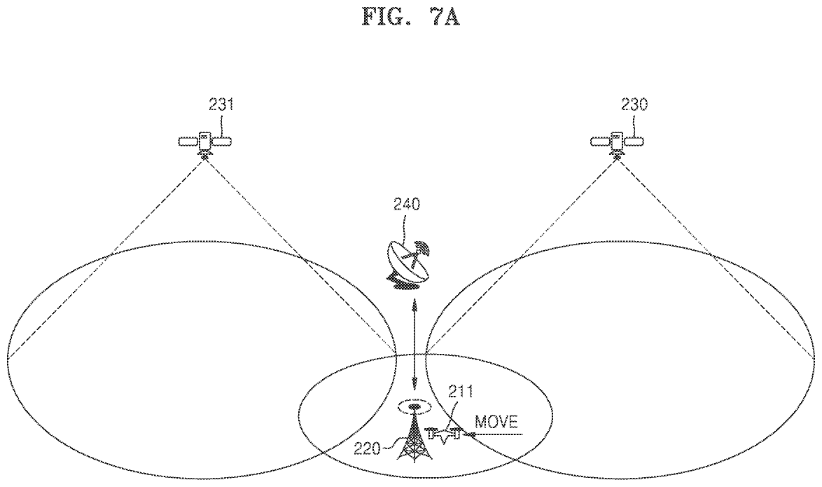

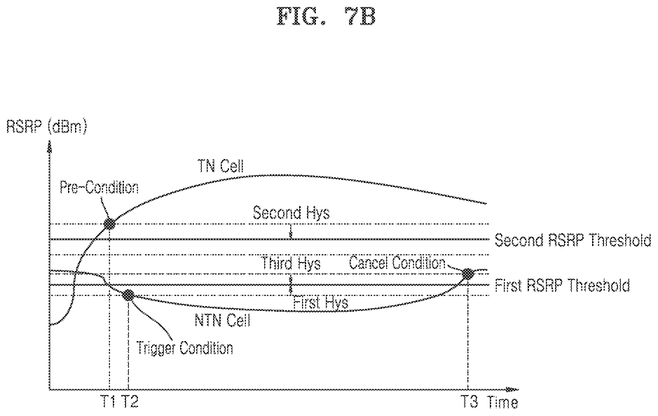

FIG. 7A illustrates a handover scenario according to an embodiment. In FIG. 7A, a coverage of a cell for the satellite 230 is greater than a coverage of a cell for the base station 220. The UE 211 may have a flight capability. For example, the UE 211 may be a drone or an airplane. The UE 211 may move from an overlapping area between the TN cell and the NTN cell to an area in which only the TN cell is served. For example, the UE 211 may move, at a high speed, from the overlapping area between the TN cell and the NTN cell to the area in which only the TN cell is served. Accordingly, the UE 211 needs to hand over from the NTN cell to the TN cell.

FIG. 7B illustrates an example of RSRP over time of each of the TN cell and the NTN cell in the handover scenario of FIG. 7A. FIG. 7B illustrates RSRP of each of the TN cell and the NTN cell when the UE 211 moves from an NTN cell area to an area in which the TN cell and the NTN cell overlap. The UE 211 is connected to an NTN cell served by the satellite 230. In FIG. 7B, the RSRP of the NTN cell has a less degree of change than the RSRP of the TN cell.

A sixth handover may be based on an NTN, from the NTN to the TN. The UE 211 may receive, from the satellite 230, a measurement control message including information regarding the sixth handover. The measurement control message may include at least one of a Trigger Condition, a Cancel Condition, and a pre-condition for the sixth handover.

Here, the Trigger Condition and the Cancel Condition are related to a first reference signal received by the UE 211 from the satellite 230. The pre-condition is related to a second reference signal received by the UE 211 from the base station 220.

The measurement control message may include a first RSRP threshold and a first Hys parameter for the Trigger Condition. The measurement control message may include a second RSRP threshold and a second Hys parameter for the pre-condition. The measurement control message may include the first RSRP threshold and a third Hys parameter for the Cancel Condition.

The UE 211 may receive the first reference signal from the satellite 230, and may measure RSRP for the received first reference signal. The Trigger Condition for the RSRP of the first reference signal may be expressed as in Equation 14 below.

RSRP of NTN cell<first RSRP threshold−first Hys [Equation 14]

In Equation 14, the RSRP of the TN cell may be a result of measuring the first reference signal received by the UE 210 from the base station 220. The first RSRP threshold may be a threshold of the RSRP of the TN cell for triggering the sixth handover or canceling the trigger of the sixth handover. The first Hys may be a Hys parameter for the trigger of the sixth handover.

The UE 210 may receive the second reference signal from the base station 220, and may measure RSRP for the received second reference signal. The Pre-Condition for the RSRP of the second reference signal may be expressed as in Equation 15 below.

RSRP of TN cell>second RSRP threshold+second Hys [Equation 15]

In Equation 15, the RSRP of the TN cell may be a result of measuring the second reference signal received by the UE 211 from the base station 220. The second RSRP threshold may be a threshold (a minimum value) of RSRP at which the UE 211 may identify the second reference signal transmitted by the base station 220. The second Hys may be a Hys parameter for the Pre-Condition of the sixth handover. The second RSRP threshold (the minimum value) of the sixth handover may be less than the second RSRP of the second handover.

The UE 211 may transmit a measurement report to the base station 220 when the RSRP of the NTN cell satisfies the Trigger Condition and the RSRP of the TN cell satisfies the Pre-Condition. Accordingly, a handover procedure may start.

The Cancel Condition may be expressed as in Equation 16 below.

RSRP of NTN cell>first RSRP threshold+third Hys [Equation 16]

In Equation 16, the RSRP of the NTN cell may be a result of measuring the first reference signal received by the UE 211 from the satellite 230. The first RSRP threshold may be a threshold of the RSRP of the TN cell for triggering the sixth handover or canceling the trigger of the sixth handover. The third Hys may be a Hys parameter for the cancellation of the sixth handover.

In FIG. 7B, the Pre-Condition may start at T1. The Trigger Condition may start at T2. The Cancel Condition may start at T3. T1 may precede T2. When the RSRP of the NTN cell, which is a serving cell, is not recovered and a sixth handover procedure to the TN cell is completed, the UE 211 may be provided with a service in the TN cell. When the Cancel Condition is satisfied before the sixth handover procedure is completed, the UE 211 may transmit a measurement report to the satellite 230. Accordingly, the handover procedure may be canceled. Accordingly, the UE 211 may be continuously provided with a service in the NTN cell.

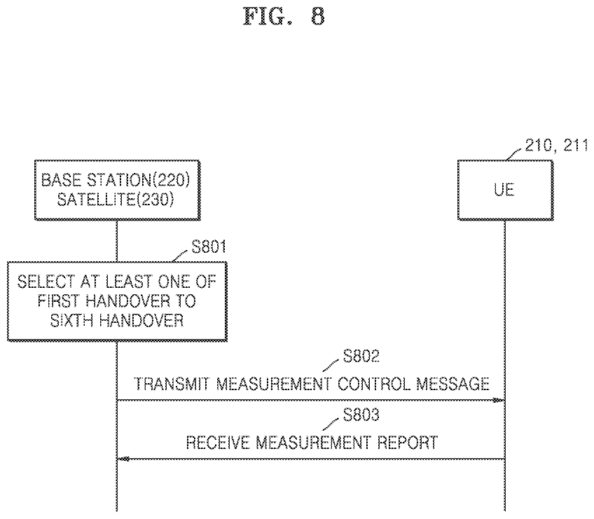

FIG. 8 illustrates an operation procedure of a base station or a satellite, according to an embodiment. FIG. 8 may be described with reference to FIGS. 2A to 7B.

In FIG. 8, in operation S801, the base station 220 or the satellite 230 may select at least one of the first handover to the sixth handover described above. The base station 220 or the satellite 230 may select a handover event by considering at least one of a configuration of a network and a type of service. The base station 220 or the satellite 230 may select the handover event by considering a distribution of one or more base stations and one or more satellites. The base station 220 or the satellite 230 may select the handover event by considering Quality of Service (QoS). In addition, the base station 220 or the satellite 230 may select the handover event by considering a type of UE 210 or 211.

For example, the base station 220 or the satellite 230 may select the first handover or the second handover to perform a handover according to RSRP received by the UE 210 or 211.

For another example, when a service coverage of a TN is wide and thus the base station 220 (on the ground) mainly provides a service to the UE 210 and an NTN provides a service to the UE 211 in an area that may not be covered by the TN, the base station 220 or the satellite 230 may select the third handover or the fourth handover. A coverage of a cell for the base station 220 is less than a coverage of a cell for the satellite 230, but a coverage of a TN including one or more base stations may be greater than a coverage of an NTN.

As another example, when the UE 211 is provided with a service demanding high data throughput, such as a high-quality video stream, the base station 220 or the satellite 230 may select the third handover or the fourth handover.

As another example, when a service coverage of a TN is narrow and thus an NTN mainly provides a service to the UE 211 and the TN provides a service to the UE 211 in an area that may not be covered by the NTN, the base station 220 or the satellite 230 may select the fifth handover or the sixth handover.

As another example, when the UE 211 moves at a high speed, the base station 220 or the satellite 230 may select the fifth handover or the sixth handover to minimize the number of handovers by using a wide coverage of the NTN cell. Accordingly, the UE 211 may be provided with a seamless service.

In operation S802, the base station 220 or the satellite 230 may transmit a measurement control message to the UE 211. The measurement control message may include information regarding a handover selected by the base station 220 or the satellite 230.

In operation S803, the base station 220 or the satellite 230 may receive a measurement report from the UE 211. The UE 211 may receive the measurement control message, and may transmit the measurement report to the base station 220 or the satellite 230 when a condition for the handover is satisfied.

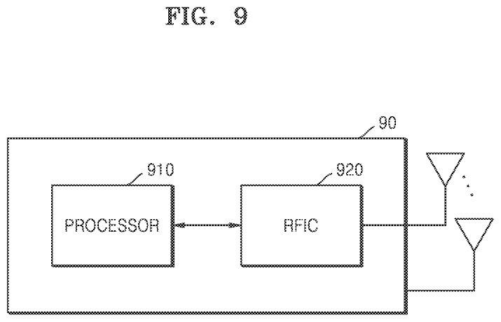

FIG. 9 is a block diagram illustrating a wireless communication apparatus according to an embodiment. FIG. 9 may be described with reference to FIGS. 2A to 7B.

In FIG. 9, a wireless communication apparatus 90 may include one or more processors 910 and one or more Radio Frequency Integrated Circuits (RFICs) 920. The processor 910 may control the RFIC 920, and may be configured to implement an operation method and operation flowcharts of the wireless communication apparatus 90 of the disclosure. The wireless communication apparatus 90 may include a plurality of antennas, and the RFIC 920 may transmit and receive wireless signals via one or more antennas. At least some of the plurality of antennas may correspond to a transmission antenna. The transmission antenna may transmit a wireless signal to an external apparatus (e.g., another UE, or a base station) other than the wireless communication apparatus 90. At least the other some of the plurality of antennas may correspond to a reception antenna. The reception antenna may receive a wireless signal from the external apparatus.

For example, the processor 910 may receive, from the base station 220 on the ground via the RFIC 920, configuration information including at least one of a Pre-Condition, a Trigger Condition, and a Cancel Condition for a handover from the base station 220 to the satellite 230. The processor 910 may receive, via the RFIC 920, a first reference signal from the base station 220 and a second reference signal from the satellite 230, respectively, and may measure RSRP of each of the first reference signal and the second reference signal. The processor 910 may transmit a first measurement report to the base station 220 via the RFIC 920 when the Trigger Condition related to the first reference signal and the pre-condition related to the second reference signal are satisfied.

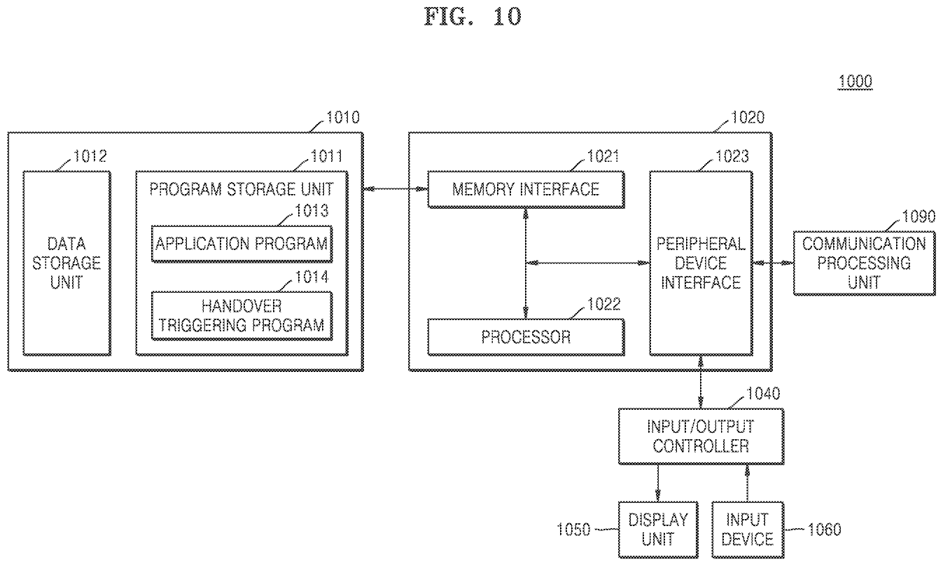

FIG. 10 is a block diagram illustrating an electronic device 1000 according to an embodiment. In FIG. 10, the electronic device 1000 may include a memory 1010, a processor unit 1020, an input/output controller 1040, a display unit 1050, an input device 1060, and a communication processing unit 1090. Here, a plurality of memories 1010 may be provided. Each component will be described below.

The memory 1010 may include a program storage unit 1011 for storing a program for controlling operation of the electronic device 1000, and a data storage unit 1012 for storing data generated during program execution. The data storage unit 1012 may store data needed for operations of an application program 1013 and a handover triggering program 1014. The program storage unit 1011 may include the application program 1013 and the handover triggering program 1014. Here, the program included in the program storage unit 1011 may be a set of instructions and thus may be expressed as an instruction set.

The application program 1013 includes an application program operating in the electronic device 1000. In other words, the application program 1013 may include an instruction of an application driven by a processor 1022. The handover triggering program 1014 may determine, on the basis of handover information received from the base station 220 or the satellite 230, whether or not a handover event condition is satisfied, according to embodiments.

A peripheral device interface 1023 may control a connection between an input/output peripheral device of the base station 220, and the processor 1022 and a memory interface 1021. The processor 1022 controls the base station 220 to provide a corresponding service by using at least one software program. Here, the processor 1022 may provide a service corresponding to a corresponding program by executing at least one program stored in the memory 1010.

The input/output controller 1040 may provide an interface between an input/output device, such as the display unit 1050 and the input device 1060, and the peripheral device interface 1023. The display unit 1050 displays state information, an input character, a moving picture, a still picture, and the like. For example, the display unit 1050 may display application program information driven by the processor 1022.

The input device 1060 may provide input data generated by selection of the electronic device 1000 to the processor unit 1020 via the input/output controller 1040. Here, the input device 1060 may include a keypad including at least one hardware button, a touch pad for detecting touch information, or the like. For example, the input device 1060 may provide touch information, such as touch, touch movement, or touch release detected via the touch pad, to the processor 1022 via the input/output controller 1040. The electronic device 1000 may include the communication processing unit 1090 that performs a communication function for voice communication and data communication.

Embodiments have been described in the drawings and description. Although the embodiments have been described by using particular terms herein, these terms are used only for describing the spirit of the disclosure and are not used to limit the meaning or limit the scope of the disclosure defined by claims. While the disclosure has been particularly shown and described with reference to embodiments thereof, it will be understood that various changes in form and details may be made therein without departing from the spirit and scope of the following claims.

What is claimed is:

1. A method of a user equipment in a wireless communication system, the method comprising:
receiving, from a base station, configuration information comprising at least one of a pre-condition, a trigger condition, and a cancel condition for a handover from the base station to a satellite;
receiving a first reference signal from the base station and a second reference signal from the satellite, respectively;
measuring Reference Signal Received Power (RSRP) of each of the first reference signal and the second reference signal; and
transmitting a first measurement report to the base station, based on a determination that the trigger condition related to the first reference signal and the pre-condition related to the second reference signal are satisfied.

2. The method of claim 1, wherein the configuration information comprises at least one of a first RSRP threshold of the first reference signal, a first Hysteresis (Hys) parameter for the first reference signal, a second RSRP threshold of the second reference signal, a second Hys parameter for the second reference signal, and a third Hys parameter for the first reference signal,
wherein the first RSRP threshold is different from the second RSRP threshold, and
wherein the first Hys parameter is different from the second Hys parameter.

3. The method of claim 2, wherein the trigger condition comprises a condition in which the RSRP of the first reference signal is less than a value obtained by subtracting the first Hys parameter from the first RSRP threshold.

4. The method of claim 2, wherein the pre-condition comprises a condition in which the RSRP of the second reference signal is greater than a sum of the second RSRP threshold and the second Hys parameter, and the second RSRP threshold comprises a minimum value at which the RSRP of the second reference signal is measured.

5. The method of claim 2, wherein the cancel condition comprises a condition in which the RSRP of the first reference signal is greater than a sum of the first RSRP threshold and the third Hys parameter.

6. The method of claim 5, further comprising transmitting a second measurement report to the base station based on the cancel condition that is satisfied after transmitting the first measurement report and before completing the handover.

7. The method of claim 6, wherein, based on the handover that is completed after transmitting the first measurement report and the cancel condition that is satisfied, the second measurement report is not transmitted.

8. The method of claim 1, wherein a coverage of a target cell for the satellite comprises a coverage of a serving cell for the base station.

9. The method of claim 1, wherein the user equipment has a flight capability.

10. A method of a user equipment in a wireless communication system, the method comprising:
receiving, from a satellite, configuration information including at least one of a trigger condition and a cancel condition for a handover from the satellite to a base station;
receiving a reference signal from the base station;
measuring Reference Signal Received Power (RSRP) of the received reference signal; and
transmitting a first measurement report to the satellite based on a determination that the trigger condition related to the received reference signal is satisfied,
wherein the configuration information comprises at least one of an RSRP threshold of the received reference signal and a hysteresis (Hys) parameter for the received reference signal.

11. The method of claim 10, wherein the trigger condition comprises a condition in which the RSRP of the received reference signal is greater than a sum of the RSRP threshold and the Hys parameter.

12. The method of claim 10, wherein the cancel condition comprises a condition in which the RSRP of the received reference signal is less than a value obtained by subtracting the Hys parameter from the RSRP threshold.

13. The method of claim 12, further comprising transmitting a second measurement report to the satellite based on the cancel condition that is satisfied after transmitting the first measurement report and before completing the handover.

14. The method of claim 13, wherein, based on the handover that is completed after transmitting the first measurement report and the cancel condition that is satisfied, the second measurement report is not transmitted.

15. The method of claim 10, wherein a coverage of a serving cell for the satellite comprises a coverage of a target cell for the base station.

16. The method of claim 10, wherein the user equipment has a flight capability.

17. A method of user equipment in a wireless communication system, the method comprising:
receiving, from a base station, configuration information including at least one of a trigger condition and a cancel condition for a handover from the base station to a satellite;
receiving a reference signal from the satellite, and measuring Reference Signal Received Power (RSRP) of the received reference signal; and
transmitting a first measurement report to the base station based on a determination that the trigger condition related to the received reference signal is satisfied,
wherein the configuration information comprises at least one of an RSRP threshold of the received reference signal and a Hysteresis (Hys) parameter for the received reference signal.

18. The method of claim 17, wherein the trigger condition comprises a condition in which the RSRP of the received reference signal is greater than a sum of the RSRP threshold and the Hys parameter.

19. The method of claim 17, wherein the cancel condition comprises a condition in which the RSRP of the received reference signal is less than a value obtained by subtracting the Hys parameter from the RSRP threshold, and
the method further comprises transmitting a second measurement report to the base station based on the cancel condition that is satisfied after transmitting the first measurement report and before completing the handover.

20. The method of claim 17, wherein a coverage of a serving cell for the base station overlaps a coverage of one or more target cells for one or more satellites including the satellite, and the user equipment has a flight capability.
